(19) United States
(12) Patent Application Publication
(10) Pub. No.: US 2016/0138998 A1
(43) Pub. Date: May 19, 2016

(54) NOISE DETECTION METHOD, NOISE DETECTION APPARATUS AND ELECTRONIC EQUIPMENT

(71) Applicant: Sony Corporation, Tokyo (JP)

(72) Inventor: Donghong ZHENG, Beijing (CN)

(21) Appl. No.: 14/796,452

(22) Filed: Jul. 10, 2015

(30) Foreign Application Priority Data
Nov. 19, 2014 (CN) 201410664319.4

(51) Int. Cl. G01M 7/02; G01N 29/12

(52) U.S. Cl. CPC G01M 7/022; G01N 29/12; G01M 7/025

(57) ABSTRACT

Embodiments of this application provide a noise detection method, noise detection apparatus and electronic equipment. The noise detection apparatus is used to detect a noise characteristic of electronic equipment and includes: an analyzing unit configured to analyze vibration signals at vibration of the electronic equipment, so as to acquire frequency characteristics of the vibration signals; and a calculating unit configured to calculate a parameter reflecting the noise characteristic of the electronic equipment according to an analysis result of the analyzing unit. According to the embodiments of this application, the noise characteristic of the electronic equipment is detected by calculating a ratio between effective intensity and base wave intensity of a total harmonic wave at vibration of the electronic equipment, thereby more conveniently and accurately detecting whether the electronic equipment is prone to generate a noise.

### CROSS-REFERENCE TO RELATED APPLICATION AND PRIORITY CLAIM

This application claims the benefit of Chinese Patent Application Serial No. 201410664319.4, filed Nov. 19, 2014, the entire disclosure of which is hereby incorporated by reference.

### TECHNICAL FIELD

The present disclosure relates to the field of noise detection technologies, and in particular to a noise detection method, noise detection apparatus and electronic equipment.

### BACKGROUND ART

As technologies and sciences develop, portable electronic equipment has become indispensable daily necessaries of people. In some scenarios needing quietness, electronic equipment may warn a user by vibrating. For example, when a call, information or an email is received and/or an alarm clock time comes, a built-in vibrator of the electronic equipment generates vibration, so that the electronic equipment vibrates to warn the user.

It should be noted that the above description of the background art is merely provided for clear and complete explanation of the present disclosure and for easy understanding by those skilled in the art. And it should not be understood that the above technical solution is known to those skilled in the art as it is described in the background art of the present disclosure.

### SUMMARY

It was found by the inventors of this application that when electronic equipment vibrates, a relatively loud noise will be sent out sometimes, thereby posing interference to a quiet environment. It was further found by the inventors that looseness or drop of some parts inside the electronic equipment may cause the electronic equipment to generate relatively intense harmonic waves with normal vibration frequencies, and these harmonic waves will cause relative large noises; and as these harmonic waves share some energies originally belonging to base waves, whether the electronic equipment is prone to generate a noise may be judged by calculating a ratio between effective intensity of a total harmonic wave and base wave intensity at vibration of the electronic equipment.

Embodiments of this application provide a noise detection method, noise detection apparatus and electronic equipment. A noise characteristic of the electronic equipment is detected according to the ratio between effective intensity of a total harmonic wave and base wave intensity at vibration of the electronic equipment, thereby conveniently detecting electronic equipment which is prone to generate a noise.

According to a first aspect of the embodiments of this application, there is provided a noise detection apparatus, used to detect a noise characteristic of electronic equipment, the noise detection apparatus including:

an analyzing unit or module (in this application the term unit and the term module may be used equivalently and interchangeably) configured to analyze vibration signals at vibration, e.g., during vibration or occurrence of vibrating or in the course of vibrating, of the electronic equipment, so as to acquire frequency characteristics of the vibration signals; and

a calculating unit configured to calculate a parameter reflecting the noise characteristic of the electronic equipment according to an analysis result of the analyzing unit.

According to a second aspect of the embodiments of this application, the noise detection apparatus further includes:

a vibrating unit configured to generate vibration, so as to make the electronic equipment to vibrate.

According to a third aspect of the embodiments of this application, the noise detection apparatus further includes:

a detecting unit configured to detect the vibration signals at the vibration of the electronic equipment.

According to a fourth aspect of the embodiments of this application,

the vibration signals include signals at vibration of the electronic equipment in three directions orthogonal to each other.

According to a fifth aspect of the embodiments of this application,

the analyzing unit is configured to perform fast Fourier transformation on the vibration signals, so as to acquire base wave information and harmonic wave information of the vibration signals in a frequency domain.

According to a sixth aspect of the embodiments of this application,

the calculating unit is configured to calculate a ratio between effective intensity of a total harmonic wave and base wave intensity according to the base wave information and harmonic wave information, and take the ratio as the parameter reflecting the noise characteristic of the electronic equipment.

According to a seventh aspect of the embodiments of this application,

the ratio between effective intensity of a total harmonic wave and base wave intensity is total harmonic distortion.

According to an eighth aspect of the embodiments of this application, the detecting unit of the noise detection apparatus includes an acceleration sensor.

According to a ninth aspect of the embodiments of this application, wherein the noise detection apparatus further includes:

an early warning unit configured to send out an early warning signal when the parameter reflecting the noise characteristic of the electronic equipment exceeds a predefined threshold value.

According to a tenth aspect of the embodiments of this application, there is provided electronic equipment, including the noise detection apparatus as described in any one of the first to the ninth aspects.

According to an eleventh aspect of the embodiments of this application, there is provided a noise detection method, used to detect a noise characteristic of electronic equipment, the noise detection method including:

analyzing vibration signals at vibration of the electronic equipment, so as to acquire frequency characteristics of the vibration signals; and

calculating a parameter reflecting the noise characteristic of the electronic equipment according to the frequency characteristics of the vibration signals.

According to a twelfth aspect of the embodiments of this application, the noise detection method further includes:

driving the electronic equipment to vibrate.

According to a thirteenth aspect of the embodiments of this application, the noise detection method further includes:

detecting the vibration signals at the vibration of the electronic equipment.

According to a fourteenth aspect of the embodiments of this application,

the vibration signals include signals at vibration of the electronic equipment in three directions orthogonal to each other.

According to a fourteenth aspect of the embodiments of this application, the analyzing vibration signals includes:

performing fast Fourier transformation on the vibration signals, so as to acquire base wave information and harmonic wave information of the vibration signals in a frequency domain.

According to a sixteenth aspect of the embodiments of this application, calculating a parameter reflecting the noise characteristic of the electronic equipment includes:

calculating a ratio between effective intensity of a total harmonic wave and base wave intensity according to the base wave information and harmonic wave information, and taking the ratio as the parameter reflecting the noise characteristic of the electronic equipment.

According to a seventeenth aspect of the embodiments of this application, the noise detection method further includes:

sending out an early warning signal when the parameter reflecting the noise characteristic of the electronic equipment exceeds a predefined threshold value.

An advantage of the embodiments of the present disclosure exists in that the noise characteristic of the electronic equipment is detected by calculating a ratio between effective intensity and base wave intensity of a total harmonic wave at vibration of the electronic equipment, thereby more conveniently and accurately detecting whether the electronic equipment is prone to generate a noise.

With reference to the following description and drawings, embodiments of the present disclosure are disclosed in detail, and principles of the present disclosure and the manners of use are indicated. It should be understood that the scope of the embodiments of the present disclosure is not limited thereto. The embodiments of the present disclosure contain many alternations, modifications and equivalents within the spirit and scope of the terms of the appended claims.

Features that are described and/or illustrated with respect to one embodiment may be used in the same way or in a similar way in one or more other embodiments and/or in combination with or instead of the features of the other embodiments.

It should be emphasized that the terms “includes/including” and “comprise/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may further obtain other drawings according to these accompanying drawings without making an inventive effort. In the drawings:

FIG. 1 is a schematic diagram of the structure of a noise detection apparatus of Embodiment 1 of this application;

FIG. 2 is a schematic diagram of the structure of a noise detection apparatus of Embodiment 2 of this application;

FIGS. 3(A)-3(C) are schematic diagrams of vibration signals of embodiments of this application;

FIGS. 4(A)-4(B) are schematic diagrams of frequency domain signals of the vibration signals of the embodiments of this application;

FIG. 5 is a schematic diagram of the systematic structure of electronic equipment of Embodiment 3 of this application; and

FIG. 6 is a flowchart of a noise detection method of Embodiment 4 of this application.

### DETAILED DESCRIPTION

Many aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

### Embodiment 1

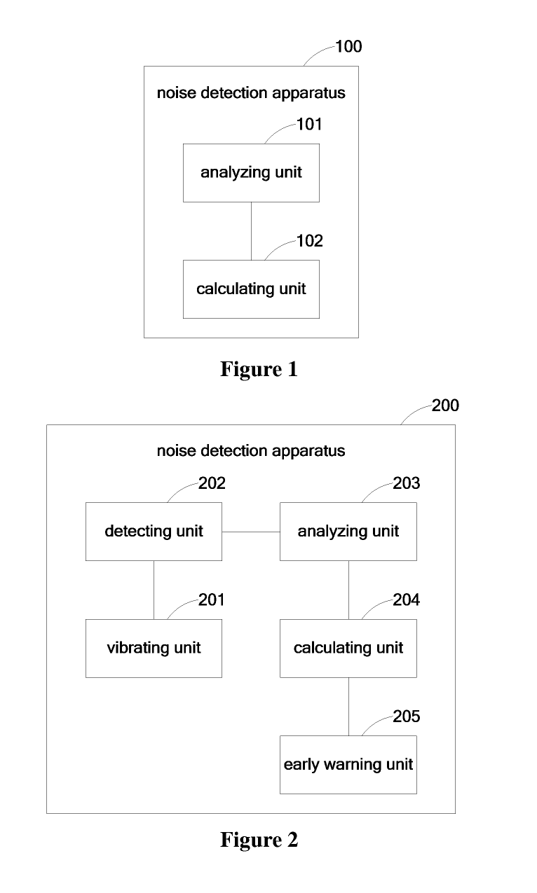

An embodiment of this application provides a noise detection apparatus, which is used to detect a noise characteristic of electronic equipment. FIG. 1 is a schematic diagram of the structure of the noise detection apparatus of Embodiment 1 of this application. As shown in FIG. 1, the noise detection apparatus 100 may include an analyzing unit 101 and a calculating unit 102.

The analyzing unit 101 is configured to analyze vibration signals at vibration of the electronic equipment, so as to acquire frequency characteristics of the vibration signals; and the calculating unit 102 is configured to calculate a parameter reflecting the noise characteristic of the electronic equipment according to an analysis result of the analyzing unit 101.

It can be seen from the above embodiment that after the electronic equipment generates vibration, the noise detection apparatus may obtain vibration signals at the vibration of the electronic equipment, and may obtain the parameter reflecting the noise characteristic of the electronic equipment by analyzing and calculating the signals, thereby detecting whether the electronic equipment is prone to generate a noise according to the parameter.

In this embodiment, the vibration signals of the electronic equipment may be expressed as, for example, an “amplitude-time” relationship curve of the electronic equipment in a vibration direction.

In this embodiment, the electronic equipment may vibrate in three directions orthogonal to each other, and the vibration signals may be signals at the vibration of the electronic equipment in three directions orthogonal to each other. Of course, this embodiment is not limited thereto, and the electronic equipment may vibrate in one or two directions, and the vibration signals may be signals at the vibration of the electronic equipment in one or two directions.

In the embodiment of this application, the analyzing unit 101 may synthesize the vibration signals, and transfer the synthesized signals to a frequency domain, so as to obtain frequency characteristics. For example, the analyzing unit 101 may directly add up or add up in a weighted manner the signals at the vibration of the electronic equipment in three directions orthogonal to each other to obtain the synthesized signals, and perform fast Fourier transformation (FFT) on the synthesized signals, so as to obtain signals of the synthesized vibration signals at the frequency domain, and hence obtain base wave information and harmonic wave information of the frequency domain signals. The base wave information and harmonic wave information may be, for example, such information as central frequencies, and intensity, etc., of a base wave and a harmonic wave. Of course, this embodiment is not limited thereto, and the analyzing unit 101 may also use other methods to obtain frequency characteristics of the vibration signals.

In the embodiment of this application, the calculating unit 102 may calculate a ratio between effective intensity of a total harmonic wave and base wave intensity, such as total harmonic distortion (THD), etc., according to the base wave information and harmonic wave information obtained by the analyzing unit 101, and take the ratio as the parameter reflecting the noise characteristic of the electronic equipment. The total harmonic distortion is a ratio between amplitude of harmonic wave and amplitude of base wave, i.e. a ratio between a value obtained by extracting a square sum of amplitudes of all the harmonic waves and the amplitude of the base wave.

For example, the calculating unit 102 may calculate the total harmonic distortion according to formula (1) below:

$$THD = \frac{\sqrt{{V}_{2}^{2} + {V}_{3}^{2} + {V}_{4}^{2} + … + {V}_{n}^{2}}}{{V}_{1}} . \qquad ( 1 )$$

In the above formula (1), V₁ denotes intensity of a base wave in the frequency domain signals, and Vₖ denotes intensity of a k-th harmonic wave in the frequency domain signals; wherein, k is a natural number, 2≦k≦n, n being a total number of harmonic waves in the frequency domain signals. And in the above formula (1), a central frequency fₖ of the harmonic wave of the k-th time is k times of a central frequency f₁ of the base wave.

Furthermore, in this embodiment, the ratio between effective intensity of a total harmonic wave and base wave intensity may be other parameters, such as a ratio between a square sum of amplitudes of the harmonic waves and a square of amplitudes of the base waves, etc., and this embodiment is not limited thereto.

In the embodiment of this application, when the ratio between effective intensity and base wave intensity of a total harmonic wave is denoted as total harmonic distortion, larger total harmonic distortion shows that the electronic equipment is more prone to generate a noise, and a larger noise is generated when it vibrates. Hence, the noise characteristic of the electronic equipment may be accurately detected by calculating the total harmonic distortion. Of course, this embodiment is not limited thereto. For example, when the ratio between effective intensity and base wave intensity of a total harmonic wave is denoted as another parameter, it is possible that a smaller parameter shows that the electronic equipment is more prone to generate a noise.

Furthermore, in this embodiment, a built-in vibrator or an external vibrator of the electronic equipment may be made to vibrate, so that the electronic equipment vibrates. In this embodiment, detection may be performed by a built-in detector, such as an acceleration sensor, of the electronic equipment, so as to obtain the vibration signals of the electronic equipment; and detection may also be performed by an external detector of the electronic equipment, so as to obtain the vibration signals of the electronic equipment.

According to the embodiment of this application, the noise characteristic of the electronic equipment is detected by calculating the ratio between effective intensity of a total harmonic wave and base wave intensity at vibration of the electronic equipment, thereby more conveniently and accurately detecting whether the electronic equipment is prone to generate a noise.

The analyzing unit 101 and the calculating unit 102 in this embodiment shall be described below by way of examples.

In this embodiment, the electronic equipment may vibrate in three directions, X, Y and Z, and the vibration signals shown in FIG. 3 are obtained by detecting acceleration in the above three directions for 256 times, respectively. Wherein, FIG. 3(A), FIG. 3(B) and FIG. 3(C) are “amplitude-time” relationship curves in X direction, Y direction and Z direction, respectively. In each curve, the horizontal axis denotes the time, with a unit of millisecond, and the vertical axis denotes the amplitude, with a unit of centimeter/millisecond.

The analyzing unit 101 adds up amplitudes corresponding to identical times in the “amplitude-time” relationship curves in X direction, Y direction and Z direction to obtain synthesized curves, and performs fast Fourier transformation (FFT) on the synthesized curves to obtain frequency signals, and hence acquires base wave intensity and harmonic wave intensity.

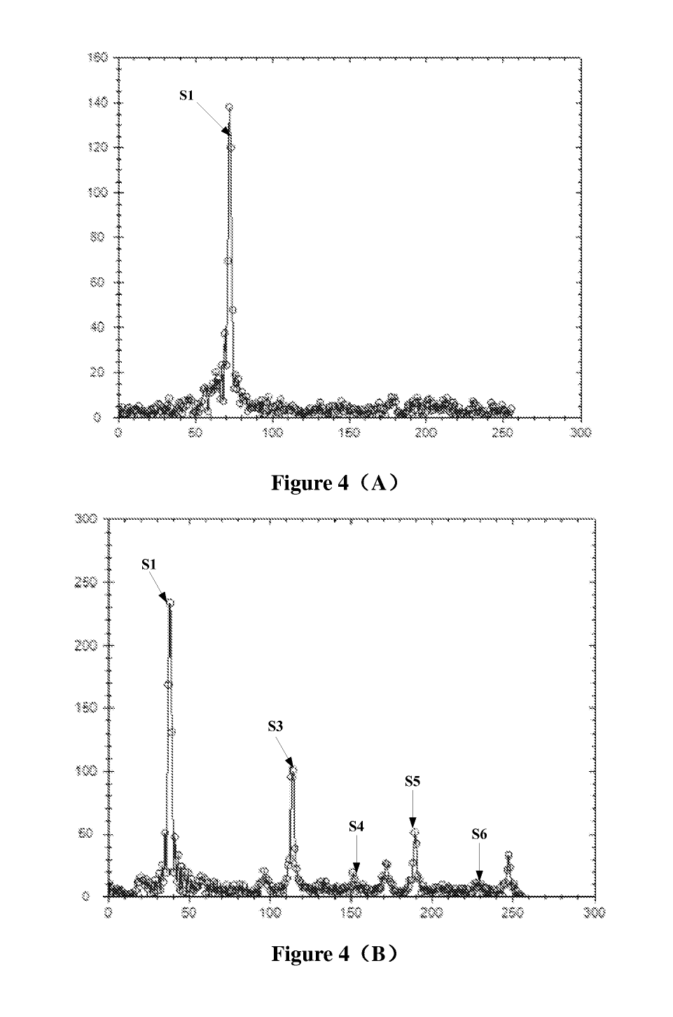

For example, FIG. 4(A) and FIG. 4(B) are frequency signals obtained according to vibration signals of electronic equipment A and electronic equipment B, respectively. Wherein, the horizontal axis denotes a frequency, with a unit of Hertz (Hz), the vertical axis denotes intensity, with a unit of centimeter/millisecond, Si denotes a base wave, and S3-S6 denote a third harmonic wave to a sixth harmonic wave respectively. It can be seen from FIG. 4(A) and FIG. 4(B) that intensity of harmonic waves of the electronic equipment A is relatively lower in vibration, and intensity of harmonic waves of the electronic equipment B is relatively higher in vibration.

The calculating unit 102 respectively calculates total harmonic distortion (THD) according to the above formula (1). For example, harmonic distortion to which FIG. 4(A) and FIG. 4(B) correspond respectively is 9.1% and 78.5%, respectively. Therefore, it may be judged that a noise characteristic of the electronic equipment A is relatively better, and a noise characteristic of the electronic equipment B is relatively poorer.

### Embodiment 2

Embodiment 2 of this application provides a noise detection apparatus, which is based on the noise detection apparatus of Embodiment 1.

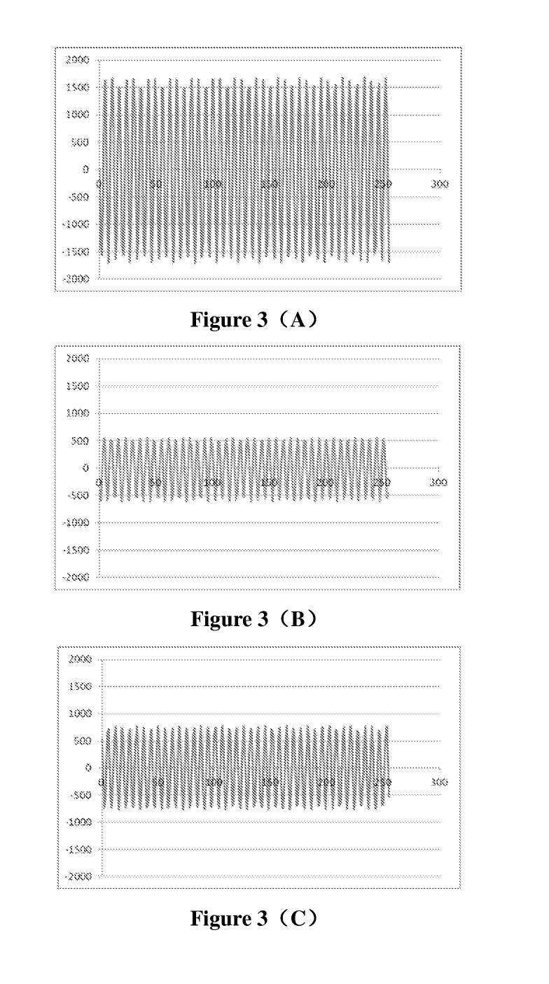

FIG. 2 is a schematic diagram of the structure of the noise detection apparatus of Embodiment 2 of this application. As shown in FIG. 2, the noise detection apparatus 200 may include a detecting unit 202, an analyzing unit 203 and a calculating unit 204.

The detecting unit 202 may be configured to detect the vibration signals at the vibration of the electronic equipment, the analyzing unit 203 may be configured to analyze vibration signals of the electronic equipment detected by the detecting unit 202, so as to acquire frequency characteristics of the vibration signals, and the calculating unit 204 may be configured to calculate a parameter reflecting the noise characteristic of the electronic equipment according to an analysis result of the analyzing unit 203.

In the embodiment of this application, the functions of the analyzing unit 203 and the calculating unit 204 are identical to those of the analyzing unit 101 and the calculating unit 102 in FIG. 1, which shall not be described herein any further.

In the embodiment of this application, the detecting unit 202 may include a motion sensor and a first calculating unit. Hence, the detecting unit 202 may detect mechanical movement of the electronic equipment in vibration, so as to obtain vibration signals. For example, the motion sensor may be an acceleration sensor, which may be fixedly connected to the electronic equipment, so as to detect acceleration of the electronic equipment in vibration. The first calculating unit may calculate the acceleration, for example, the operation may be an integral operation, etc., so as to obtain an “amplitude-time” relationship curve of the electronic equipment in a vibration direction, which is taken as a vibration signal of the electronic equipment.

In another aspect of the embodiment of this application, the detecting unit 202 may include an acoustic wave sensor and a second calculating unit. Hence, the detecting unit 202 may detect an acoustic wave emitted by the electronic equipment in vibration, so as to obtain a vibration signal according to the acoustic wave. For example, the acoustic wave sensor may be a microphone, which may detect an acoustic wave signal emitted by the electronic equipment in vibration, and the second calculating unit may obtain vibration signals of the electronic equipment according to the acoustic wave signal and corresponding relationship between a vibration signal and an acoustic wave signal of a vibration source.

The above description of the detecting unit 202 is illustrative only, this embodiment is not limited thereto, and the detecting unit 202 may be other types of detecting elements capable of detecting vibration.

As shown in FIG. 2, in this embodiment, the noise detection apparatus 200 may further include a vibrating unit 201 capable of generating vibration, so that the electronic equipment is made to vibrate.

In the embodiment of this application, the electronic equipment may be in contact with the vibrating unit 201 directly or indirectly, and when the vibrating unit 201 generates vibration, energies of the vibration are transferred to the electronic equipment, so that the electronic equipment is made to vibrate.

In the embodiment of this application, the vibrating unit 201 may be, for example, a vibrator consisting of a micro motor and an eccentric wheel, or a vibrator consisting of a piezoelectric crystal. Of course, this application is not limited thereto, and the vibrating unit 201 may be other types of vibrators known in this field.

As shown in FIG. 2, in this embodiment, the noise detection apparatus 200 may further include an early warning unit 205, which is configured to send out an early warning signal when the parameter reflecting the noise characteristic of the electronic equipment exceeds a predefined threshold value.

In this embodiment, the early warning unit may include a judging portion and an early warning portion. The judging portion may compare a parameter reflecting the noise characteristic of the electronic equipment calculated by the calculating unit 204, such as total harmonic wave distortion, with a predefined threshold value, judge that the electronic equipment is prone to generate a noise when the parameter is greater than the predefined threshold value, and send out an early warning indication signal to the early warning portion. The early warning portion sends out an early warning signal after receiving the early warning indication signal. For example, the early warning portion may be a display and/or a loudspeaker, etc. Hence, when the early warning indication signal is received, an image and/or word information may be displayed on the display and/or an early warning sound may be sent out via the loudspeaker.

In this embodiment, with the early warning unit 205, the following problem may be solved: in some cases, although looseness or dropping of some parts inside the electronic equipment may occur and the noise characteristic of the electronic equipment changes, the user may not find abnormality of vibration noise of the electronic equipment, and hence does not check the electronic equipment in time, thereby resulting in more server vibration noise and affecting electrical performance of the electronic equipment.

In this embodiment, with the early warning unit 205, the user is warned in case of degradation of the noise characteristic of the electronic equipment, so that the user checks the electronic equipment in time, thereby repairing a loosened or dropped part.

According to this embodiment, the noise detection apparatus may make the electronic equipment to vibrate and detect a vibration signal. Therefore, the noise characteristic of the electronic equipment is detected by calculating a ratio between effective intensity and base wave intensity of the total harmonic wave of the electronic equipment in vibration, so as to more conveniently and accurately detect the noise characteristic of the electronic equipment; and the noise detection apparatus may further warn the user in case of degradation of the noise characteristic of the electronic equipment, so that the user checks the electronic equipment in time.

### Embodiment 3

This embodiment provides electronic equipment, including the noise detection apparatus as described in Embodiment 1 or Embodiment 2.

In this embodiment, the electronic equipment may be a mobile phone, a smart watch, a smart band, a digital camera, a tablet personal computer, or a personal computer, etc. however, this embodiment is not limited thereto, and it may also be other types of electronic equipment.

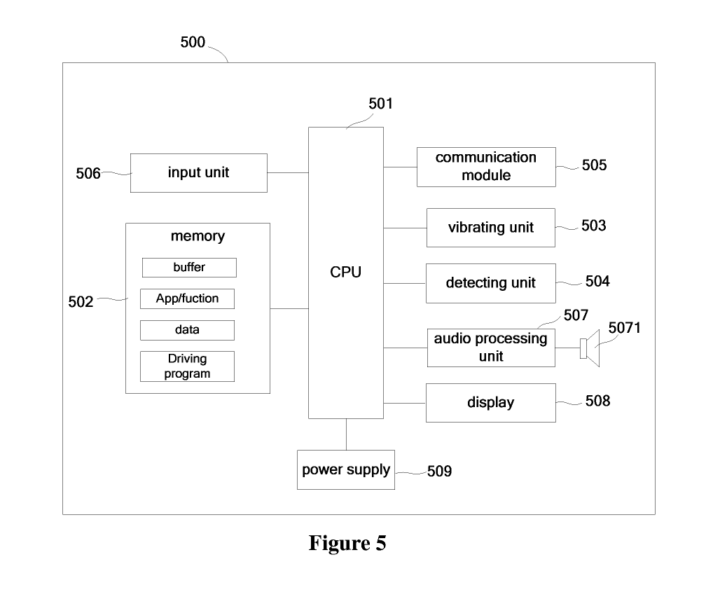

FIG. 5 is a schematic diagram of the systematic structure of electronic equipment 500 of the embodiment of this application. As shown in FIG. 5, the electronic equipment 500 may include a central processing unit 501, a memory 502, a vibrating unit 503 and a detecting unit 504. The memory 502 is coupled to the central processing unit 501, and the vibrating unit 503 is capable of generating vibration, so that the electronic equipment vibrates. For example, the vibrating unit 503 may be a vibrator consisting of a micro motor and an eccentric wheel. The detecting unit 504 may detect vibration signals of the electronic equipment in vibration. For example, the detecting unit 504 may include an acceleration sensor. It should be noted that such a figure is exemplary only, and other types of structures may be used to supplement or replace this structure for the realization of telecommunications functions or other functions.

In a mode of implementation, functions of the analyzing unit and the calculating unit of the noise detection apparatus may be integrated into the central processing unit 501. The central processing unit 501 may be configured to: analyze vibration signals at vibration of the electronic equipment, so as to acquire frequency characteristics of the vibration signals; and calculate a parameter reflecting the noise characteristic of the electronic equipment according to an analysis result of the analyzing unit; wherein, the vibration signals include signals at vibration of the electronic equipment in three directions orthogonal to each other.

The central processing unit 501 may be further configured to: perform fast Fourier transformation on the vibration signals, so as to acquire base wave information and harmonic wave information of the vibration signals in a frequency domain.

The central processing unit 501 may be further configured to: calculate a ratio between effective intensity of a total harmonic wave and base wave intensity according to the base wave information and harmonic wave information, and take the ratio as the parameter reflecting the noise characteristic of the electronic equipment. The ratio between effective intensity and base wave intensity of a total harmonic wave may be total harmonic wave distortion.

The central processing unit 501 may be further configured to: control the detecting unit, so as to detect vibration signals of the electronic equipment in vibration.

The central processing unit 501 may be further configured to: control the vibrating unit to make the vibrating unit to generate vibration, so that the electronic equipment vibrates.

The central processing unit 501 may be further configured to: send out an early warning indication signal when the parameter reflecting the noise characteristic of the electronic equipment exceeds a predefined threshold value. For example, the early warning indication signal may be sent to a display and/or an audio processor of the electronic equipment, so that a loudspeaker to which the display and/or the audio processor is connected sends out an early warning signal. Embodiment 2 may be referred to for the description of the early warning indication signal and the early warning signal, which shall not be described herein any further.

In another mode of implementation, the noise detection apparatus and the central processing unit 501 may be configured separately. For example, the noise detection apparatus may be configured as a chip connected to the central processing unit 501, with the functions of the noise detection apparatus being realized under control of the central processing unit.

As shown in FIG. 5, the electronic equipment 500 may further include a communication module 505, an input unit 506, an audio processing unit 507, a display 508, and a power supply 509. The audio processing unit 507 and/or the display 508 may receive an early warning indication signal from the central processing unit 501 or the noise detecting unit 501 configured separately from the central processing unit 501, and sends out a warning sound via a loudspeaker 5071 connected to the audio processing unit 507, and/or displays an image and/or word information via the display 508. It should be noted that the electronic equipment 500 does not necessarily include all the parts shown in FIG. 5; furthermore, the electronic equipment 500 may include other parts not shown in FIG. 5, and the prior art may be referred to for these parts.

As shown in FIG. 5, the central processing unit 501 is sometimes referred to as a controller or control, and may include a microprocessor or other processor devices and/or logic devices. The central processing unit 501 receives inputs and controls operations of all the components of the electronic equipment 500.

The memory 502 may be, for example, one or more of a buffer memory, a flash memory, a hard drive, a mobile medium, a volatile memory, a nonvolatile memory, or other suitable devices, which may store store a program executing related information. The central processing unit 501 may execute the program stored in the memory 502, so as to realize information storage or processing, etc. Functions of other parts are similar to those of the prior art, which shall not be described herein any further. The parts of the electronic equipment 500 may be realized by specific hardware, firmware, software, or any combination thereof, without departing from the scope of this application.

In this embodiment, the electronic equipment 500 may be made to vibrate by the built-in vibrating unit 503, and vibration signals of the electronic equipment in vibration are in-time detected by the built-in detecting unit 504 of the electronic equipment. Furthermore, frequency characteristics of the vibration signals are analyzed, and the noise characteristic of the electronic equipment is detected by calculating a ratio between effective intensity and base wave intensity of a total harmonic wave of the electronic equipment in vibration, thereby more conveniently and accurately detecting whether the electronic equipment is prone to generate a noise; and the user is warned in case of degradation of the noise characteristic of the electronic equipment, so that the user checks the electronic equipment in time.

### Embodiment 4

Embodiment 4 of this application provides a noise detection method, which corresponds to the noise detection apparatus described in Embodiment 1.

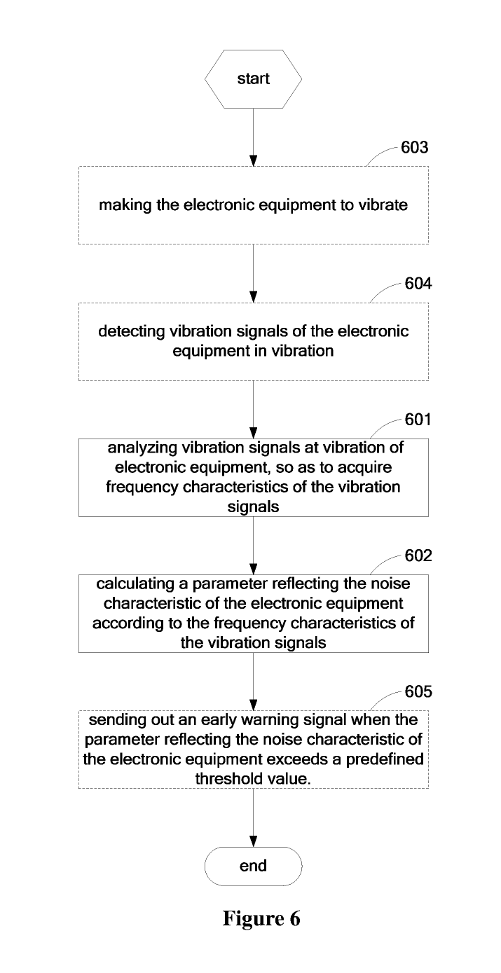

FIG. 6 is a flowchart of the noise detection method. As shown in FIG. 6, the method includes:

S601: analyzing vibration signals at vibration of electronic equipment, so as to acquire frequency characteristics of the vibration signals; and

S602: calculating a parameter reflecting the noise characteristic of the electronic equipment according to the frequency characteristics of the vibration signals.

In S601, for example, fast Fourier transformation may be performed to the vibration signals, so as to acquire base wave information and harmonic wave information of the vibration signals in a frequency domain. The vibration signals may be, for example, signals at vibration of the electronic equipment in three directions orthogonal to each other.

In S602, for example, a ratio between effective intensity of a total harmonic wave and base wave intensity may be calculated according to the base wave information and harmonic wave information, and is taken as the parameter reflecting the noise characteristic of the electronic equipment; wherein, the ratio between effective intensity of a total harmonic wave and base wave intensity may be, for example, total harmonic distortion.

In the embodiment of this application, prestored detected vibration signals may be acquired in S601. Furthermore, in the embodiment of this application, vibration of the electronic equipment may be detected on site, so as to acquire real-time vibration signals. For example, as shown in FIG. 6, the noise detection method may further include:

S603: making the electronic equipment to vibrate; and

S604: detecting vibration signals of the electronic equipment in vibration.

Furthermore, as shown in FIG. 6, the noise detection method may include:

S605: sending out an early warning signal when the parameter reflecting the noise characteristic of the electronic equipment exceeds a predefined threshold value.

Refer to the description of the units of the noise detection apparatus in embodiments 1 and 2 for detailed description of the steps in Embodiment 4, which shall not be described herein any further.

According to the embodiments of this application, the noise characteristic of the electronic equipment is detected by calculating a ratio between effective intensity and base wave intensity of a total harmonic wave at vibration of the electronic equipment, thereby more conveniently and accurately detecting electronic equipment which is prone to generate a noise. And according to the embodiments of this application, the user is warned in case of degradation of the noise characteristic of the electronic equipment, so that the user checks the electronic equipment in time.

An embodiment of the present disclosure further provides a computer-readable program, wherein when the program is executed in an information processing device or user equipment, the program enables the computer to carry out the noise detection method as described in Embodiment 4 in the information processing device or user equipment.

An embodiment of the present disclosure further provides a storage medium in which a computer-readable program is stored, wherein the computer-readable program enables the computer to carry out the noise detection method as described in Embodiment 4 in an information processing device or user equipment.

An embodiment of the present disclosure further provides a computer-readable program, wherein when the program is executed in an information processing device or a base station, the program enables the computer to carry out the noise detection method as described in Embodiment 4 in the information processing device or base station.

An embodiment of the present disclosure further provides a storage medium in which a computer-readable program is stored, wherein the computer-readable program enables the computer to carry out the noise detection method as described in Embodiment 4 in an information processing device or base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

1. A noise detection apparatus, used to detect a noise characteristic of electronic equipment, the noise detection apparatus comprising:
an analyzing unit configured to analyze vibration signals at vibration of the electronic equipment, so as to acquire frequency characteristics of the vibration signals; and
a calculating unit configured to calculate a parameter reflecting the noise characteristic of the electronic equipment according to an analysis result of the analyzing unit.

2. The noise detection apparatus according to claim 1, wherein the noise detection apparatus further comprises:
a detecting unit configured to detect the vibration signals at the vibration of the electronic equipment.

3. The noise detection apparatus according to claim 2, wherein,
the detecting unit comprises an acceleration sensor.

4. The noise detection apparatus according to claim 1, wherein the noise detection apparatus further comprises:
a vibrating unit configured to generate vibration, so that the electronic equipment is made to vibrate.

5. The noise detection apparatus according to claim 1, wherein,
the vibration signals comprise signals at vibration of the electronic equipment in three directions orthogonal to each other.

6. The noise detection apparatus according to claim 1, wherein,
the analyzing unit is configured to perform fast Fourier transformation on the vibration signals, so as to acquire base wave information and harmonic wave information of the vibration signals in a frequency domain.

7. The noise detection apparatus according to claim 6, wherein,
the calculating unit is configured to calculate a ratio between effective intensity of a total harmonic wave and base wave intensity according to the base wave information and harmonic wave information, and take the ratio as the parameter reflecting the noise characteristic of the electronic equipment.

8. The noise detection apparatus according to claim 7, wherein,
the ratio between effective intensity of a total harmonic wave and base wave intensity is total harmonic distortion.

9. The noise detection apparatus according to claim 1, wherein the noise detection apparatus further comprises:
an early warning unit configured to send out an early warning signal when the parameter reflecting the noise characteristic of the electronic equipment exceeds a predefined threshold value.

10. Electronic equipment, comprising the noise detection apparatus as described in claim 1.

11. A noise detection method, used to detect a noise characteristic of electronic equipment, the noise detection method comprising:
analyzing vibration signals at vibration of the electronic equipment, so as to acquire frequency characteristics of the vibration signals; and
calculating a parameter reflecting the noise characteristic of the electronic equipment according to the frequency characteristics of the vibration signals.

12. The noise detection method according to claim 11, wherein the noise detection method further comprises:
detecting the vibration signals at the vibration of the electronic equipment.

13. The noise detection method according to claim 11, wherein the noise detection method further comprises:
making the electronic equipment to vibrate.

14. The noise detection method according to claim 11, wherein,
the vibration signals comprise signals at vibration of the electronic equipment in three directions orthogonal to each other.

15. The noise detection method according to claim 11, wherein the analyzing vibration signals comprises:
performing fast Fourier transformation on the vibration signals, so as to acquire base wave information and harmonic wave information of the vibration signals in a frequency domain.

16. The noise detection method according to claim 15, wherein calculating a parameter reflecting the noise characteristic of the electronic equipment comprises:
calculating a ratio between effective intensity of a total harmonic wave and base wave intensity according to the base wave information and harmonic wave information, and taking the ratio as the parameter reflecting the noise characteristic of the electronic equipment.

17. The noise detection method according to claim 16, wherein,
the ratio between effective intensity of a total harmonic wave and base wave intensity is total harmonic distortion.

18. The noise detection method according to claim 11, wherein the noise detection method further comprises:
sending out an early warning signal when the parameter reflecting the noise characteristic of the electronic equipment exceeds a predefined threshold value.
